(19) United States
(12) Patent Application Publication
(10) Pub. No.: US 2004/0247967 A1
(43) Pub. Date: Dec. 9, 2004

(54) Maintaining PEM fuel cell performance with sub-freezing boot strap starts

(76) Inventors: Gennady Resnick, South Windsor, CT (US); Carl A. Reiser, Stonington, CT (US); Neil A. Popovich, Ellington, CT (US); Jung S. Yi, Mansfield Center, CT (US); Patrick L. Hagans, Columbia, CT (US)

Correspondence Address: M. P. Williams, 210 Main Street, Manchester, CT, 06040, US

(21) Appl. No.: 10/839,667

(22) Filed: May 5, 2004

Related U.S. Application Data
(63) Continuation-in-part of application No. 10/456,412, filed on Jun. 6, 2003.

(51) Int. Cl. H01M 8/04; H01M 8/02

(52) U.S. Cl. 429/26; 429/38; 429/13

(57) ABSTRACT

The fuel cells (16, 18) adjacent or near the end plate (15) of a fuel cell stack (14) are warmed either by (a) a heater wire (48, 50) within the fuel cell (16) adjacent to the end plate, (b) heater wires (53) disposed in a heater element (52) located between the end plate and the fuel cell closest to the end plate (15), (c) one or more heaters (56) are disposed in holes (55) within the end plate (15), (d) a catalytic heater (61) disposed on the inner surface of the end plate, or (e) catalytic burner (78, 100) disposed adjacent a current collector (70) between an end cell (16) and insulation (81) on an end plate (82). The fuel cells (16, 18) may be heated before or during startup at sub-freezing temperatures to prevent loss of fuel cell performance.

### CROSS REFERENCE TO RELATED APPLICATIONS

This application is a continuation-in-part of U.S. patent application Ser. No. 10/456,412, filed Jun. 6, 2003.

### TECHNICAL FIELD

This invention relates to utilizing heat at or near the end cell and/or adjacent pressure plate (also known as end plate or current collector) in PEM fuel cells which are started at sub-freezing temperatures, to avoid cells with degraded performance.

### BACKGROUND ART

When proton exchange membrane (PEM) fuel cells are started at sub-freezing temperatures, either directly with the intended load, such as an electric vehicle powered by such cell, or by means of an auxiliary load, or both, the cells adjacent to the end plates (current collectors, or pressure plates) exhibit unacceptably poor performance, which is especially pronounced in the cells close to the cathode end of the cell stack assembly.

Although it has been shown that the performance loss may be mitigated or even cured completely by dry-out or by forcing protons to move in the cathode-to-anode direction, sometimes called a “hydrogen pump”, both of these procedures are too complicated for satisfactory use by users, particularly with respect to a fuel cell powering an electric vehicle.

The problem is different in prior art systems since all of the individual cells are brought up to proper operating temperature before startup, by circulation of preheated coolant through the stack. Such systems are illustrated in U.S. Pat. Nos. 5,132,174 and 6,649,293. In a fuel cell operated according to that prior methodology, the coolant is first brought up to temperature, after which the coolant is circulated through the fuel cell for a time before each of the cells reach normal operating temperature. In a fuel cell operating a vehicle at sub-freezing temperatures, the delay of 15 minutes (or more) to achieve cell operating temperature would be intolerable.

In U.S. Pat. No. 6,103,410, a dilute H₂/air stream is fed to the process oxidant channels of all fuel cells of the stack to warm them up before operation. U.S. Pat. No. 6,649,293 shows electric heating elements on the inner surface of an end plate.

The large thermal mass of end plates makes it very difficult to input sufficient heat in the required time when heaters attached to the outside of the pressure plates are turned on at the same time the startup is initiated. Heating with external heaters before the startup is initiated is effective in preventing loss of performance but requires a power source other than the fuel cell. Another problem with external heaters is the fact that typical pressure plate designs make it impossible to cover the entire outside surface of the pressure plate, due to load cable attachments and other apparatus, which results in non-uniform heating of the pressure plate. Finally, these heaters are inefficient due to radiation away from the pressure plate.

### DISCLOSURE OF THE INVENTION

This invention is predicated on our discovery that poor end-cell performance in a fuel cell stack assembly following boot strap startup at sub-freezing temperatures is due to the end plates, which typically comprise a very large heat sink that causes the end cells to remain at temperatures below the water freezing point for long periods of time during startup, which is unacceptable. The invention is predicated in part on our discovery that heating of the end cell, at least at the cathode end of the cell stack assembly can mitigate or eliminate the performance loss. The invention is also predicated in part on our discovery that heating of the end cells or between the end cells and the adjacent end plate can avoid loss of performance resulting from boot strap startup at sub-freezing temperatures.

According to the present invention, heat is provided in the vicinity of end cells, at least at the cathode end of a cell stack assembly, either before or during a boot strap startup (or both) at sub-freezing temperatures, to mitigate loss of performance.

In accordance with the invention, the heat may be applied directly within a fuel cell, between an end fuel cell and an end plate, or directly within an end plate, either by means of electric heat or fuel combustion, such as a catalytic heater.

The invention may be utilized with solid end plates, or with hybrid end plates having a structural, rigidizing portion composed of a composite material, such as fiberglass impregnated with resin, and a current collection plate, having a much reduced thermal mass, disposed between the composite material and the last cell of the stack.

The invention does not rely on preheated, non-freezable coolant, as is the case in prior art fuel cells.

According to the invention, loss of performance due to boot strap startups at sub-freezing temperatures is avoided by providing heat near the end cells of the cell stack assembly sufficient to warm the end cells above the freezing temperature of water.

Other objects, features and advantages of the present invention will become more apparent in the light of the following detailed description of exemplary embodiments thereof, as illustrated in the accompanying drawing.

### BRIEF DESCRIPTION OF THE DRAWINGS

FIGS. 1-5 are stylized, simplified side elevation sectional views, with sectioning lines omitted for clarity, of one and a fraction fuel cells adjacent to the end plate at the cathode end of a fuel cell stack, as follows:

FIG. 1, with heating element in the last fuel cell;

FIG. 2, with a heater element disposed between the last cell and the end plate;

FIG. 3, with a heating element inside the end plate, near the last cell;

FIG. 4, with a catalytic burner on the inner surface of the end plate.

FIG. 5, with a heating element in the last cell adjacent to an end plate which comprises a small collector plate and a composite rigidizing portion; and

FIGS. 6-9 are stylized, simplified side elevation sectional views, with sectioning lines omitted for clarity, of one and a fraction fuel cells, and various embodiments of the invention employing catalytic combustors, current collection plates, and insulation.

FIG. 10 is a fragmentary, sectioned, perspective of tubes filled with catalyst within a solid plate, forming a combustion heater.

FIG. 11 is a fragmentary, partially sectioned perspective view of an end corner of the fuel cell stack, illustrating manifolds for fuel cell reactant fuel and heater fuel.

FIG. 12 is a fractional, side elevation section of another embodiment.

### MODE(S) FOR CARRYING OUT THE INVENTION

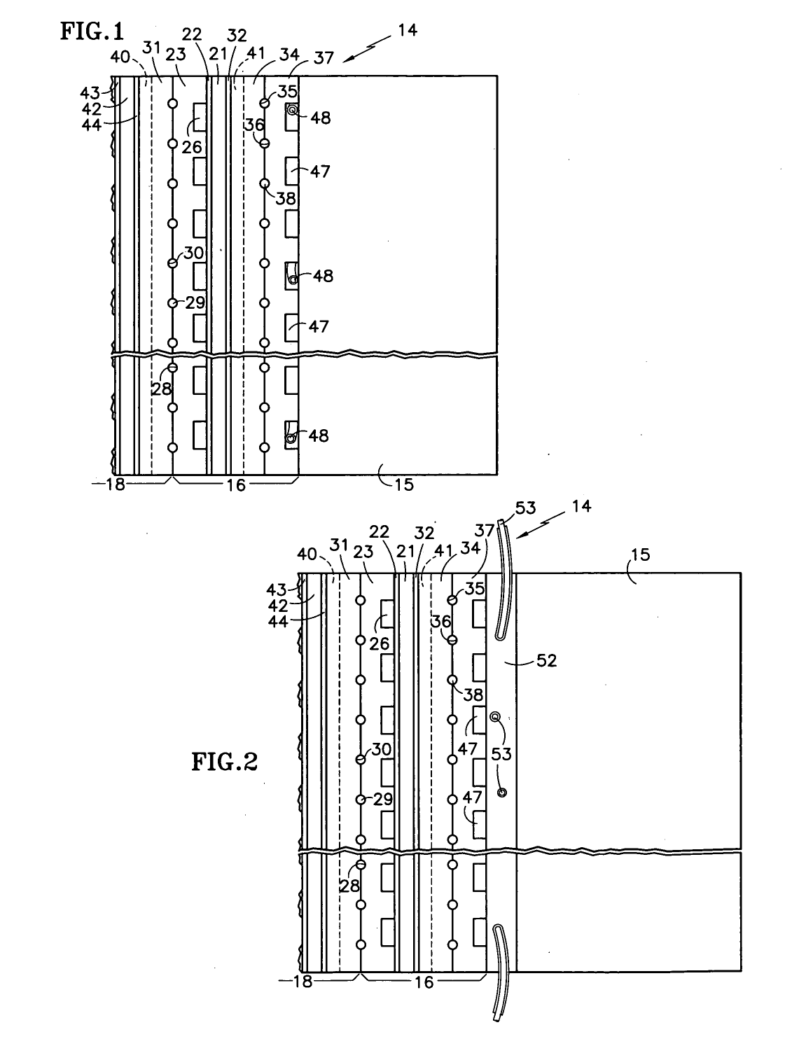

In FIG. 1. a fuel cell stack 14 has an end plate 15, which provides pressure to all the fuel cells to establish electric conduction and which typically collects load current, sometimes referred to as a “pressure plate”. Only the end active fuel cell 16 and a portion of the next-to-end active fuel cell 18, at the cathode end of the stack, are shown. As used herein, the term “inactive” is used to distinguish components of a fuel cell stack which do not have a membrane and are not capable of producing electricity. The end fuel cell comprises a membrane electrode assembly which includes a proton exchange membrane 21 together with cathode and anode catalysts on support plates 22, 32. An anode support plate 22 is adjacent to an anode water transport plate 23, which is porous and includes fuel flow field passages 26 and grooves 28 which make up coolant water passageways 29 when matched with grooves 30 on an adjacent cathode water transport plate 31. Similarly, a cathode support plate 32 is adjacent to a cathode water transport plate 34 which is porous and has grooves 35 which, when matched with grooves 36 of an additional anode water transport plate 37, will form water passages 38. The cathode water transport plate 31 of the cell 18 has oxidant reactant gas passages 40, and the cathode water transport plate 34 has oxidant reactant gas flow field passages 41. In the general case, the end plate 15 as shown in FIG. 1 also serves as the current collector, through which the generated current is supplied to a load.

The next-to-end fuel cell 18, only partially shown, includes a membrane electrode assembly 42, an anode support plate 43, and a cathode support plate 44, the remainder of this fuel cell being broken away for simplicity. The additional anode water transport plate 37, which is present simply to complete the water passages 38 for the cathode of the last fuel cell 16 does not have any fuel reactant gas flowing in channels 47.

In a first embodiment of the invention as shown in FIG. 1, insulated resistance wire 48 is threaded through some, as shown, or all, of the channels 47, as necessary, to provide sufficient heat so that the end fuel cell 16 will not be below freezing temperatures during a boot strap startup.

In a second embodiment of the invention shown in FIG. 2, a heater plate 52 has insulated resistance wire 53 embedded therein and is disposed between the additional water transport plate 37 and the end plate 15. The wire 53 may be in a zig-zag or serpentine path or in any other suitable shape as may be found desirable in any particular utilization of the present invention.

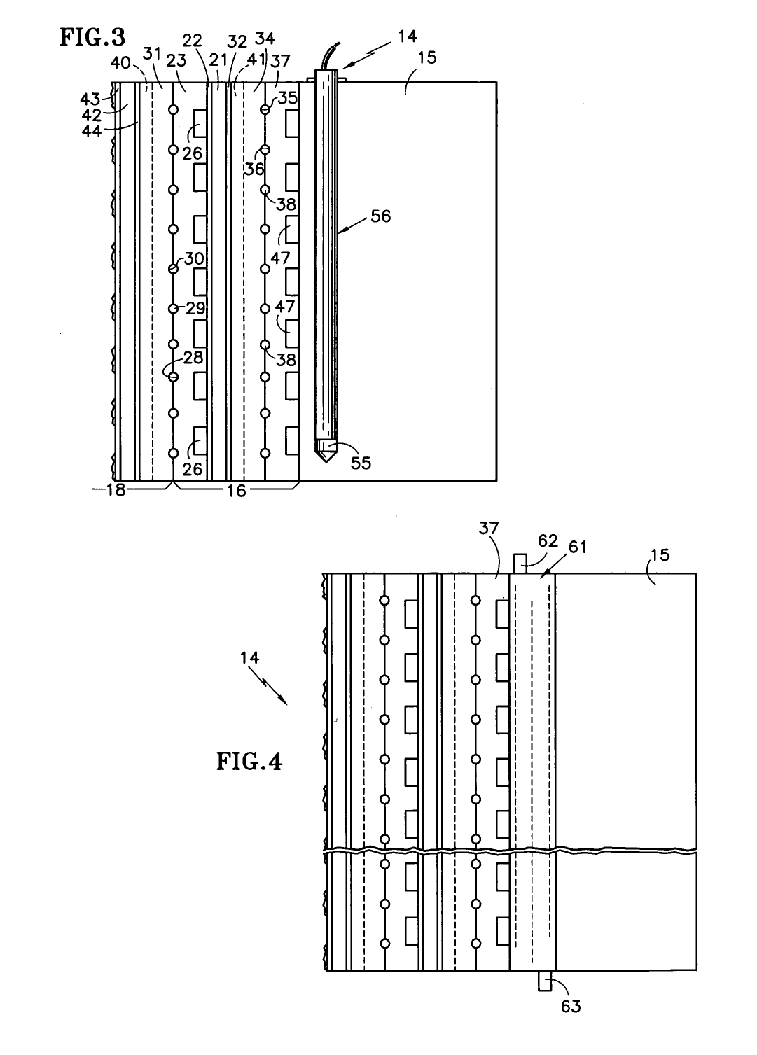

In FIG. 3, the end plate 15 has a plurality of holes 55 drilled therein (only one being shown) and a heater 56 disposed in each of the holes. Preferably, the heater 56 is disposed close to that surface of the end plate 15 which is in contact with the additional water transport plate 37. However, the heaters could be in other positions.

In FIG. 4, a catalytic burner 61 may receive fuel, such as a hydrogen rich gas or a hydrocarbon fuel, such as methanol, through a fuel inlet 62, and oxidant, such as air, through an oxidant inlet 63. Instead of a catalytic burner, any fuel oxidizing heater may be used on the inner surface of the end plate 15 which is adjacent to the surface in contact with the additional water transport plate 37.

The embodiments of FIGS. 1-4 serve not only to heat the fuel cell itself, either directly or through conduction, but also to provide a temperature gradient which isolates the fuel cell from most or all of the cold mass of the end plate 15.

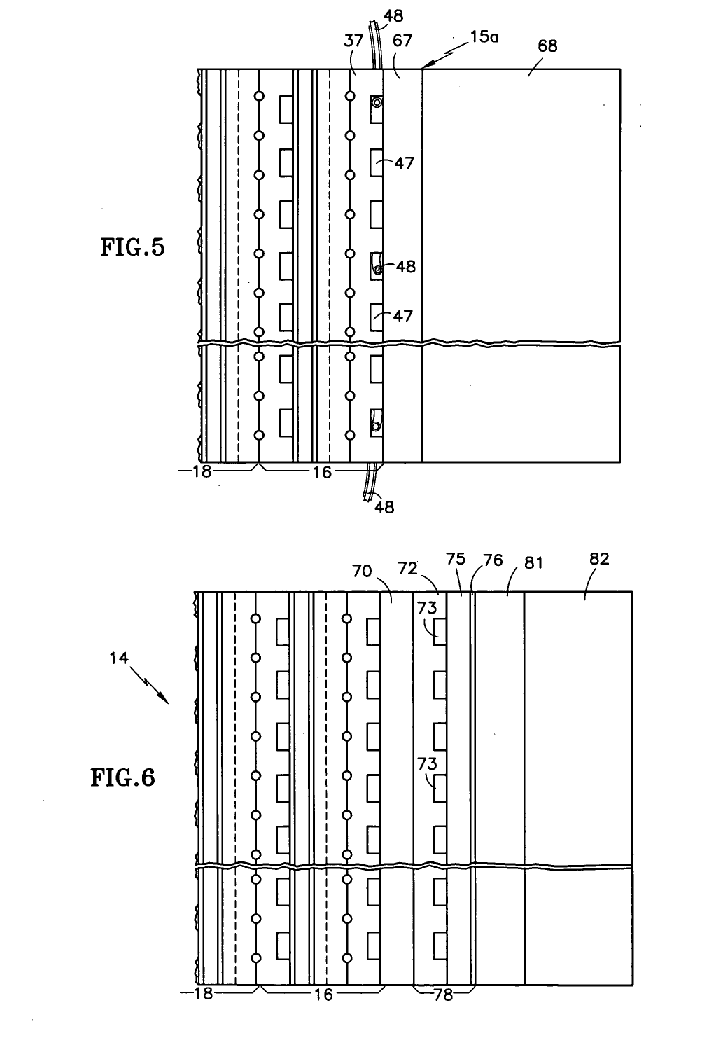

Referring to FIG. 5, an end plate 15a includes a relatively small, conductive current collector 67, and a larger rigidizing portion 68 which may be formed of composite material, such as resin reinforced fiberglass. Such a two-part end plate, having a composite section 68 and a current collector 67 is shown in copending U.S. patent application Ser. No. 10/141,612, filed May 8, 2002. The rigidizing portion 68 provides a rigid flat surface which allows applying the required pressure to the fuel cell stack by means of tie rods 69 (FIG. 10) so as to join all of the cells in one continuous electrical path. The composite rigidizing portion 68 does not operate as a huge heat sink, and therefore contributes little to cooling of the fuel cells 16, 18. FIG. 5 illustrates the embodiment of FIG. 1 being utilized with a two-part end plate 15a; the embodiments of FIGS. 2-4 are also equally useful with a two-part end plate 15a.

Thus, the invention comprises warming the fuel cells which are adjacent or near to the end plate by means of either a heater within the end fuel cell (FIGS. 1 and 5), a heater between the end fuel cell and the end plate (FIG. 2), one or more heaters within the end plate adjacent to the fuel cells (FIG. 3) or heating the inner surface of the end plate which is toward the fuel cells (FIG. 4).

FIG. 6 illustrates an embodiment of the invention at the cathode end of a fuel cell stack in which the end cell 16 is the same as that in FIGS. 2-4. Adjacent to the end cell 16 is a current collector 70 which is a solid plate and tends to provide fluid isolation between the end cell 16 and other apparatus outboard thereof in the stack 14. A fuel flow field plate 72 may be either solid or porous; if it is porous, it may be the same as the anode water transport plates 23, 37; if it had grooves 36 therein they would be of no consequence. Because this part of the embodiment is isolated from the end fuel cell 16 by the solid current collector 70, porosity will have no effect. On the other hand, the dilute fuel flow field plate 72 may be solid, if desired. The fuel for the heater 78 flows through passages 73 in the fuel flow field plate 72.

In contact with the dilute fuel flow field plate 72 is a porous substrate 75, similar to the cathode and anode catalyst support plates, having a catalyst 76 disposed thereon. The catalyst may typically be a noble metal, such as platinum. In such case, the substrate 75 and catalyst 76 may be the same as those utilized to form the anode and cathode electrodes, if desired. The flow field plate 72, substrate 75 and catalyst 76 form a heater 78, which is inactive because there is no membrane electrolyte.

The fuel for the heater 78 may be a hydrocarbon fuel such as methane, but a hydrogen-rich fuel gas is preferred. The fuel may therefore be a hydrogen-rich fuel which is derived from the same fuel as is provided to the active fuel cells in the stack, but diluted with air. The manner of regulating the hydrogen-rich fuel, controlling the mass flow thereof, mixing it with air, and checking it for flammability may be as is described in the aforementioned U.S. Pat. No. 6,103,410, and forms no part of the present invention.

Next to the heater 78 there is insulation 81 which may be any known bulk insulation, or which may be a vacuum insulated panel as is disclosed in copending U.S. patent application Ser. No. 10/687,010, filed on Oct. 16, 2003. An end plate 82 in this embodiment does not serve as a current collector, but merely compresses the cells of the stack together by means of tie bolts which are not shown.

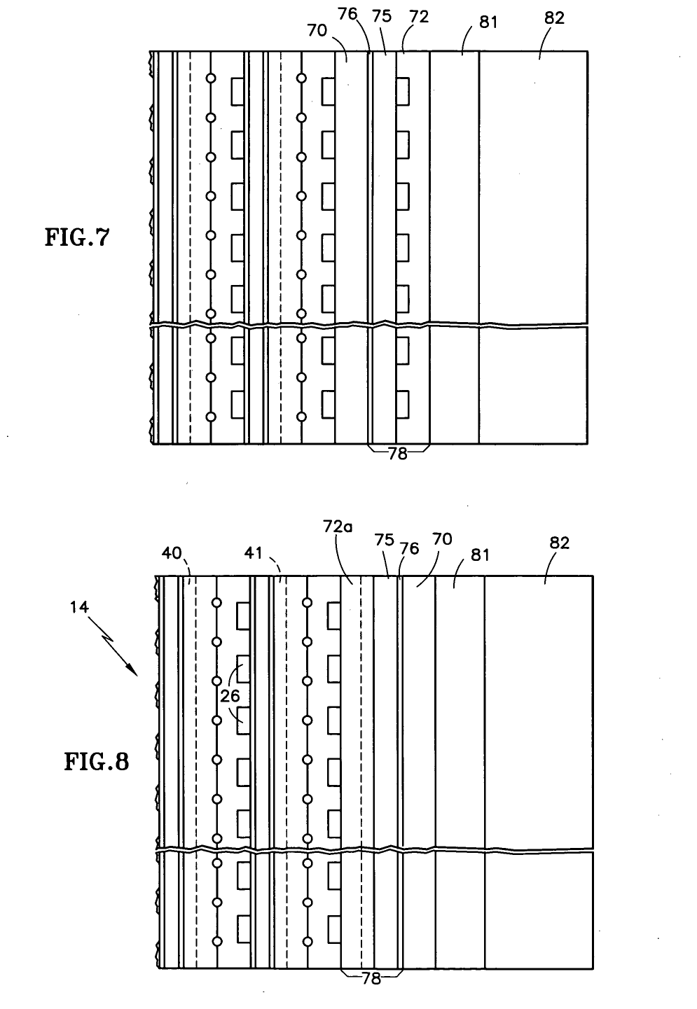

FIG. 7 illustrates that the components of the heater 78 may be in an order which is reversed from that shown in FIG. 6. That is, the catalyst 76 may be in contact with the current collector 70, and the fuel flow field plate 72 may be adjacent the insulation 81. This is irrelevant to the present invention.

FIG. 8 illustrates that the current collector 70 may be outboard of the heater 78 provided that the fuel flow field plate 72a is solid. FIG. 8 also illustrates that the channels in the fuel flow field 72a may be parallel to the air channels 40, 41 rather than being parallel to the fuel channels 26.

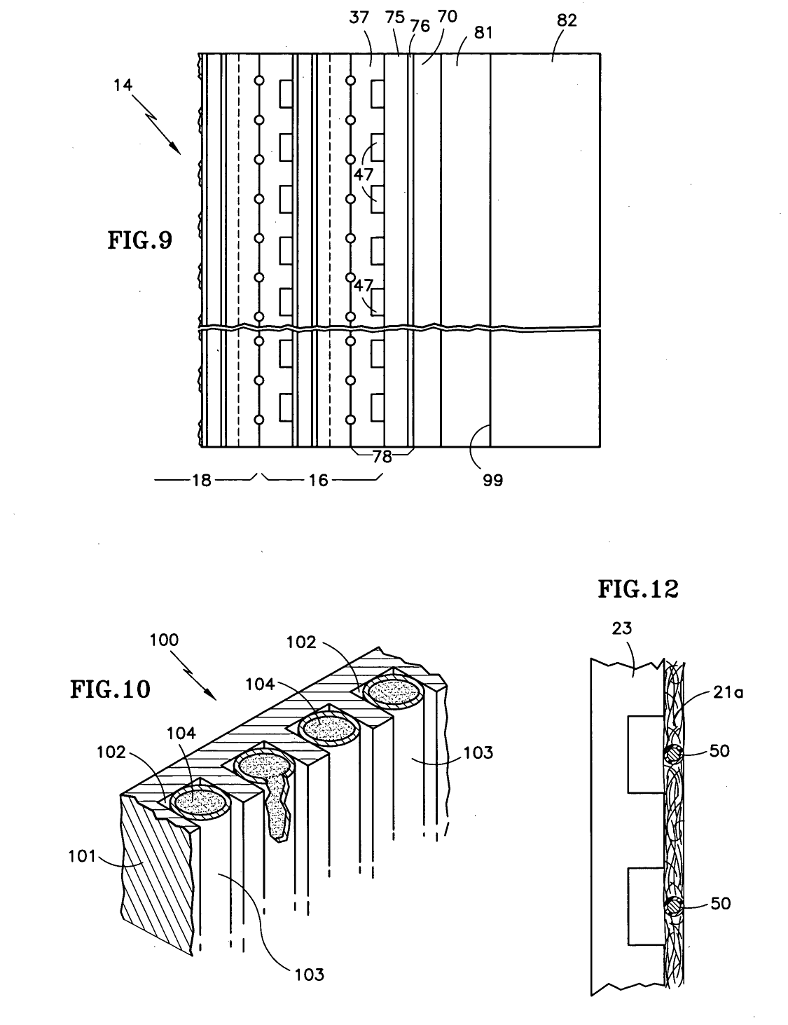

If the fuel cell is shut down in a freezing environment and the water is not drained out of the water transport plates, such as the water transport plate 31, 23, 34, 37, during a later startup, the water will be frozen, blocking the heater fuel in the passageways 47 from reaching the remainder of the end fuel cell 16 or any of the other fuel cells in the stack. As illustrated in FIG. 9, the heater 78 may comprise the additional anode water transport plate 37, which serves as a fuel flow field plate. Before the water within the additional anode water transport plate 37 melts, the fuel to the flow channels 47 will be shut off, the heater 78 thereby becoming inoperative.

In the embodiments of FIGS. 6-9, the end plate 82 is a non-current-collecting end plate, and the insulation 81 is on an inner surface 99 of the end plate, facing toward the fuel cells 16, 18. In the embodiments of FIGS. 6-8, the current collector 70, and heater 78 are disposed between the end fuel cell 16 and the insulation 81. In the embodiment of FIG. 9, the heater 78 is comprised partly of an end fuel cell 16, in that it uses the flow fields 47 of the additional anode water transport plate 37; the remainder of the heater, the substrate 75 and catalyst 76, as well as the current collector 70 are disposed between the end fuel cell 16 and the insulation 81.

The invention described with respect to FIGS. 1 and 2 may be used in fuel cells having a diffusion layer (bilayer) adjacent to the cathode catalyst, or adjacent to both the cathode and anode catalyst, if desired in any given implementation of the present invention.

Referring to FIG. 10, a combustion heater 100 may comprise a solid plate 101 having slots 102 within which tubes 103 are disposed. The tubes 103 contain a catalyst 104, typically titanium or some suitable noble metal or alloy, dispersed on any form of matrix, in a well known fashion. A heater 100 formed in a manner illustrated in FIG. 10 can be substituted for the heater 78 in FIGS. 2, 4, 6-9 and 11.

The invention also comprises warming either end of a fuel cell stack by means of a heater which combusts fuel with a catalyst, and which provides insulation between the heater and the end plate, which is made possible by using a current collector other than the end plate. The warming of the fuel cells may be before or during a boot strap startup at sub-freezing temperatures, depending on the configuration, so as to avoid degradation of fuel cell performance.

FIG. 11 is an illustration of a fuel manifold structure 90 that is modified so as to provide a fuel cell reactant fuel chamber 91 and a heater fuel chamber 92. A conventional fuel pipe 95 will provide hydrogen-rich fuel to the chamber 91, in a conventional fashion. Heater fuel, which can be diluted and regulated as in the aforementioned U.S. Pat. No. 6,103,410, may be provided to a heater fuel inlet pipe 97 for application to the chamber 92. Similar structures may be used for fuel outlet manifolds. Or, if a two-pass system is used for the fuel cell fuel manifold, then a two-pass system may be used for heater fuel as well. The detailed nature of the manifold 90 and its seals form no part of the present invention.

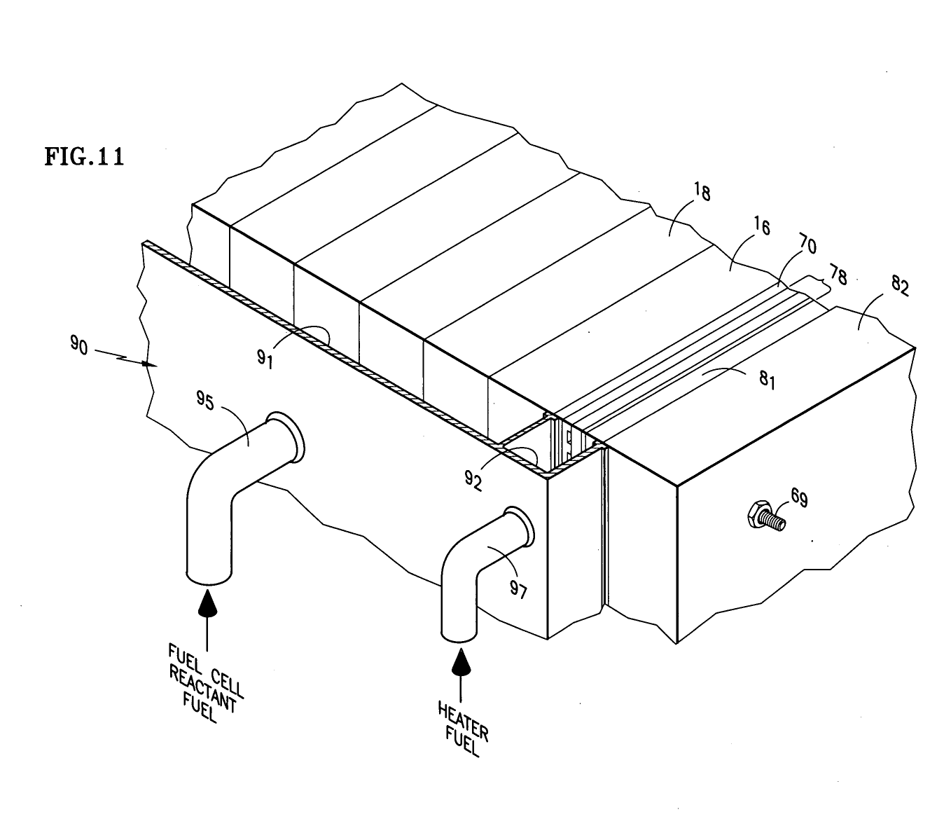

In FIG. 12, insulated heating wire 50 may be woven into the same carbon paper used as anode (and/or cathode) catalyst supports 22. The woven pattern coincides with the configuration of flow field channels 26 on the adjacent water transport plate 23.

The aforementioned patents and patent applications are incorporated herein by reference.

Thus, although the invention has been shown and described with respect to exemplary embodiments thereof, it should be understood by those skilled in the art that the foregoing and various other changes, omissions and additions may be made therein and thereto, without departing from the spirit and scope of the invention.

We claim:

1. A fuel cell system, comprising:
a plurality of fuel cells (16, 18) compressed into a stack (14) between a pair of end plates, including a first end fuel cell (18) at a cathode end of said stack and a second end fuel cell at an anode end of said stack, said end plates being either (a) current-collecting end plates (15) or (b) non-current-collecting end plates (68, 82); and
a heater (37, 52, 56, 78, 100) having either (c) an electrical resistance heating element (48, 50, 53, 56) or (d) a fuel combustor (78, 100), said heater disposed (e) within at least one of said end plates, (f) at least partly within one of said end fuel cells, or (g) within said stack in contact with a current collector comprising either (h) one of said current-collecting end plates (15), if any, or (I) a current collector plate (70) disposed near an end of said stack between one of said end fuel cells and one of said end plates.

2. A system according to claim 1 wherein:
insulated resistance wire (48) is disposed within some portion of at least one of said end fuel cells (16).

3. A system according to claim 1 wherein:
an electrically powered heater plate (53) is disposed between a current-collecting end plate (15) and one of said end fuel cells (16).

4. A system according to claim 1 wherein:
at least one heater element (56) is disposed in a hole (58) provided in at least one of said end plates.

5. A system according to claim 4 wherein:
each heater element is in a hole (56) adjacent to the inner surface of said end plate (15) which is toward said fuel cells (16, 18).

6. A system according to claim 1 wherein said end plates are non-current-collecting end plates (82) and further comprising insulation (81) disposed on an inner surface of each of said end plates, toward said fuel cells, and a current collector plate (70) disposed on a side of said insulation opposite said inner surface.

7. A system according to claim 6 wherein said current collector plate (71) and said heater (78, 100) are disposed between one of said end cells and said insulation.

8. A system according to claim 1 wherein:
said heater is a fuel combustor (78, 100); and
a fluidic fuel for said heater flows in unused reactant gas flow fields (37, 47) of one of said end fuel cells, and the remainder of said heater (78) and said current collector plate (70) are disposed between said one end cell and said insulation.

9. A system according to claim 1 wherein said heater comprises:
a porous or solid fuel flow field plate (72, 72a) through which fluid fuel flows;
a substrate (75); and
a catalyst (76) on said substrate for combusting said fuel.

10. A system according to claim 9 wherein the flow channels of said fuel flow plate are generally parallel to oxidant reactant gas flow channels of said fuel cells.

11. A system according to claim 9 wherein the flow channels of said fuel flow plate are substantially parallel to the fuel reactant gas flow channels of said fuel cells.

12. A system according to claim 1 wherein said heater is a catalytic fuel combustor (78, 100).

13. A system according to claim 1, wherein:
said heater is a fuel combustor (78, 100), and additionally comprising:
at least one manifold (92) for providing fuel to said fuel combustor.

14. A system according to claim 1, wherein:
said heater is a combustor (78, 100); and
fuel for said combustor comprises very dilute hydrogen in air.

15. A system according to claim 1 wherein:
said fuel cells each comprise anode and cathode catalysts supported on carbon paper supports; and
said heater comprises insulated heating wire (50) woven into at least one of said supports (21a).

16. A method of operating a fuel cell system having a plurality of fuel cells (16, 18) compressed into a stack (14) between a pair of end plates, including a first end fuel cell (18) at a cathode end of said stack and a second end fuel cell at an anode end of said stack, said end plates being either (a) current-collecting end plates (15) or (b) non-current-collecting end plates (68, 82), said method comprising;
providing heat either from (c) an electrical resistance heating element (48, 50, 52, 56) or (d) a fuel combustor (78, 100) disposed (e) within at least one of said end plates (15), (f) at least partly within one of said end fuel cells, or (g) within said stack in contact with a current collector comprising either (h) one of said current-collecting end plates (15), if any, or (I) a current collector plate (70) disposed near an end of said stack between one of said end fuel cells and one of said end plates.

17. A method according to claim 16 wherein:
said step of providing heat provides heat within a portion of said end plate (15) near a surface of said end plate which is toward said fuel cell (16).
